(19) United States
(12) Patent Application Publication
(10) Pub. No.: US 2004/0131436 A1
(43) Pub. Date: Jul. 8, 2004

(54) Drill tool for a rotary hammer

(76) Inventor: Markus Rompel, Runkel/Schadeck (DE)

Correspondence Address: Michael P. Leary, Black & Decker Corporation, Mail Stop TW199, 701 E. Joppa Rd, Towson, MD, 21286, US

(21) Appl. No.: 10/678,659

(22) Filed: Oct. 3, 2003

(30) Foreign Application Priority Data
Oct. 10, 2002 (GB) GB 0223520.8

(51) Int. Cl. B25B 23/00; B23B 51/00

(52) U.S. Cl. 408/226

(57) ABSTRACT

A tool, of the type suitable for use only in the drilling only mode of a rotary hammer. The tool has a shank portion at its rearward end and a drilling tip at its forward end wherein the shank portion can be releaseably locked in a tool holder of a rotary hammer by at least one locking body of the tool holder engaging a closed groove formed on the shank. The forward end of the closed groove is positioned sufficiently close to the rearward end of the tool that the rearward end of the tool is always located in the tool holder forwardly of the most forward position of a hammering mechanism of the rotary hammer. Therefore, if the hammer is inadvertently switched to a hammering mode, the hammering mechanism will not impact the drilling tool and so will not damage it or prejudice the operation of the tool.

This invention relates to a drilling tool for a rotary hammer, which is suitable for use only in the drilling only mode of the rotary hammer, for example a tile and glass cutting tool or a driving tool.

### BACKGROUND OF THE INVENTION

It is known to have tools having a circular cross-sectioned shank suitable for fitment to the tool holder of a rotary hammer. These shanks generally have at least one axially extending driving grove formed in them, which driving groves extend to the rearward end of the shank and so are open at their rearward ends. These driving grooves are engaged by corresponding driving splines formed in the tool holder of the hammer so that rotation of the tool holder rotatingly drives the tool via the splines. In addition the tool shanks are generally formed with at least one axially extending closed groove which engage cooperating locking bodies on the tool holder. The locking bodies are generally moveable between a locked position in which the locking bodies engage the closed grooves to lock the tool within the tool holder and a release position in which the locking bodies can disengage the closed grooves to allow removal and replacement of the tool. The closed grooves are axially longer than the part of the locking bodies which engage the grooves so that the tool is able to undergo limited reciprocation within the tool holder. When the rotary hammer is in hammering mode the hammering mechanism repeatedly impacts the rearward end of the tool, this causes the tool to reciprocate within the tool holder so as to transfer these impacts to the material being worked.

It is conventional to use a rotary hammer for chiselling (in a hammer only mode of the hammer), for hammer drilling and for drilling, using a selected one of a set of specially formed drilling or chisel tools, depending on the mode of hammer operation and on the material being worked.

When cutting ceramic materials such as ceramic tiles, a glass and tile cutting tool is selected comprising a shank of the type described above with a carbide arrow shaped tip fixed within a transverse notch formed at the forward end of the shank. The tile cutting tool should only be used in the drilling only mode of the hammer, because any impact on the rearward end of the tile cutting tool by the hammering mechanism when the tile cutting tool is pushed against a ceramic material to be cut is likely to result in the tip of the tool shattering. Therefore, if the hammer is inadvertently switched into its hammering or rotary hammer modes, the tile cutting tool is likely to be damaged or destroyed.

Driving tools, such as screw or nut driving tools may be formed with a shank of the type described above suitable for fitment into the tool holder of a rotary hammer. Screwdriving tools are used for rotatingly driving screws into workpieces and nut driving tools are used for rotatingly driving nuts onto corresponding shanks, with the rotary hammer set in its drilling only mode. The screws and nuts are fastened by screw threads. If the hammer is inadvertently switched to hammering mode during a screw or nut driving operation, the workpiece or shank can be damaged and the screw thread fastening between the screw or nut and corresponding workpiece or shank can also be damaged.

### BRIEF DESCRIPTION OF THE INVENTION

The present invention aims to overcome at least some of the problems discussed above by providing a tool for a rotary hammer for use only in the drilling only mode of the hammer, the operation of which tool will not be prejudiced by an inadvertent switching of the rotary hammer into a hammering mode.

According to the present invention there is provided a tool having a shank portion at its rearward end and a tip at its forward end wherein the shank portion is formed with at least one closed groove and is suitable for being releaseably locked in a tool holder of a rotary hammer by at least one locking body of a tool holder engaging a corresponding closed groove, characterised in that the forward end of the closed groove is positioned sufficiently close to the rearward end of the tool so that when the tool is locked in a tool holder of a rotary hammer, the rearward end of the tool is maintained in a position forwardly of the most forward position of a hammering mechanism of the rotary hammer.

Therefore, when a tool according to the present invention is fitted in a tool holder of a rotary hammer, if the hammer is inadvertently switched to a hammering mode, the hammering mechanism of the rotary hammer cannot impact the rearward end of the tool. This is because the tool will always be located further forwardly in the tool holder than the forwardmost position of the hammering mechanism. Thus, inadvertent switching to a hammering mode will not result in any damage to the tool or in any way prejudice the operation of the tool.

There may be a pair of opposing axially extending closed grooves formed on the shank portion of the tool, one or both of which may be engaged by a locking body on the tool holder, depending on the design of tool holder. The axial length of the closed grooves may be between 7 mm and 20 mm.

The tool may be rotatingly driven via at least one axially extending driving groove extending to and open at the rearward end of the tool which is engageable with a corresponding spline of the tool holder so as to transmit rotary drive to the tool. The axially extending driving grooves are typically between 10 mm and 12 mm long. Alternatively, the tool may be formed with a shank portion having a non-circular, preferably hexagonal, transverse cross-section via which rotary drive is transmitted from the tool holder to the tool. For example, where the transverse cross-section of the tool is hexagonal the tool holder may have a hexagonally cross-sectioned receiving bore, within which the tool is a sliding fit, in which case the rotary drive is transmitted between the tool holder and the tool by engaging hexagonal surfaces.

The tool may be a tile and glass cutting tool with a tip which is a cutting tip suitable for cutting ceramic materials, for example the cutting tip may be an arrow shaped carbide tip fixed in a transverse notch formed at the forward end of the tool.

The tool may be a driving tool, such as a screw driving or nut driving tool which has a tip suitable for rotatingly driving a screw into a workpiece or a nut onto a corresponding shank. For example, if the tool is a screw driving tool the tip of the tool may be formed as a flat-head or cross-head the tool screw driving tip.

Where the tool shank is formed with at least one axially extending driving groove the forward ends of the closed groove and the driving groove may be substantially the same distance from the rearward end of the tool.

For a tool shank with a 10 mm diameter, the forward end of the closed groove may be located less than 20 mm, preferably between 14 to 20 mm, from the rearward end of the tool shank. This limits the most rearward position of the tool shank within the tool holder to a position forward of the forwardmost position of the hammering mechanism. Therefore, the tool shank cannot be impacted by the hammering mechanism. The distance between the rearward end of the closed groove and the rearward end of the tool shank may be between 3 mm and 5 mm and the axial length of the closed groove may be between 7 mm and 20 mm, subject to the above requirement for the forward end of the closed groove to be located less than 20 mm from the rearward end of the tool shank.

### BRIEF DESCRIPTION OF THE DRAWINGS

An embodiment of a tool according to the present invention will now be described by way of example, with reference to the accompanying drawings in which:

FIG. 1 shows a longitudinal cross-section through a tile cutting tool according to the present invention;

FIG. 2 shows a perspective view of the tool of FIG. 1, rotated through 90°;

FIG. 3 shows a longitudinal cross-section through a screw driving tool according to the present invention;

FIG. 4 shows a perspective view of the tool of FIG. 3, rotated through 90°; and

FIG. 5 shows a partial longitudinal cross-section of a tool holder of a rotary hammer with the tool of FIGS. 1 and 2 or 3 and 4 locked in it.

### DETAILED DESCRIPTION OF THE INVENTION

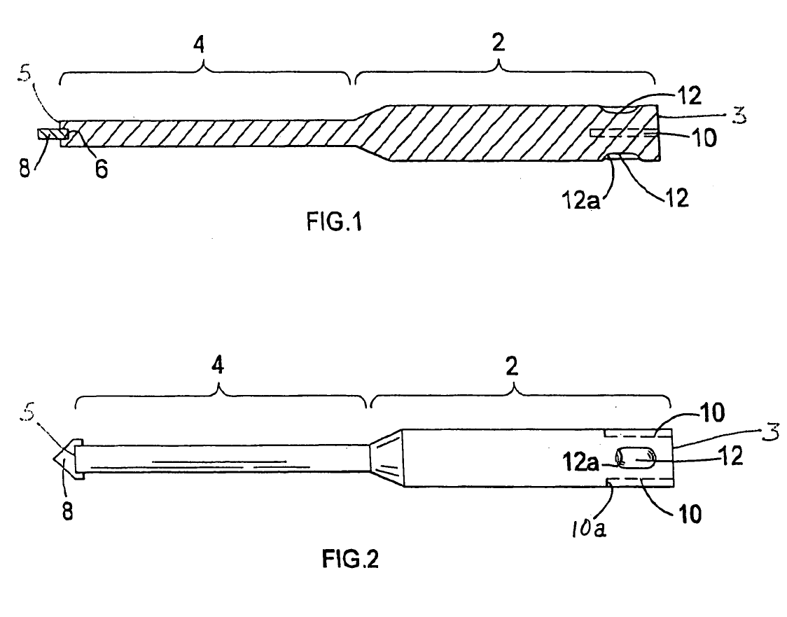

The tool of FIGS. 1 and 2 has a shank portion (2) for fitment within a tool holder of a rotary hammer and a forward portion (4) of reduced diameter, formed with a transverse notch (6) at its forward end (5). An arrow shaped carbide tip (8) suitable for cutting ceramic materials is set into the notch (6) and secured, for example, by spring loaded steel balls.

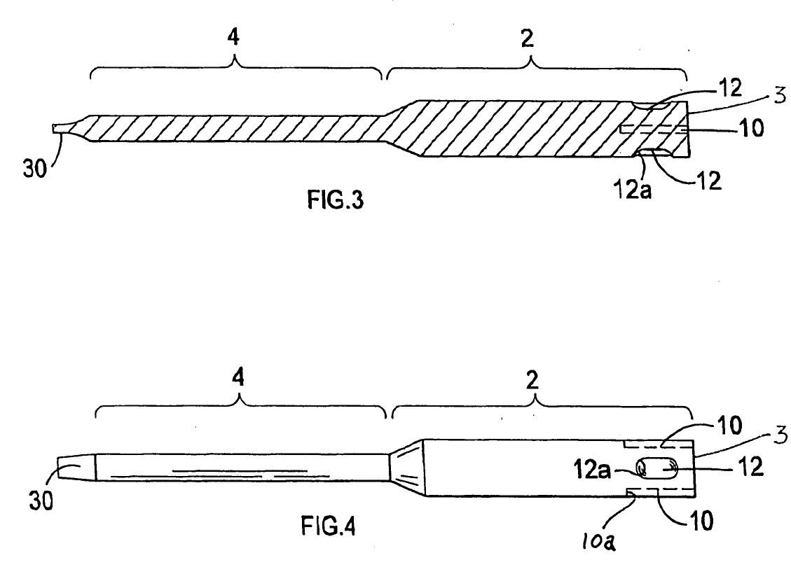

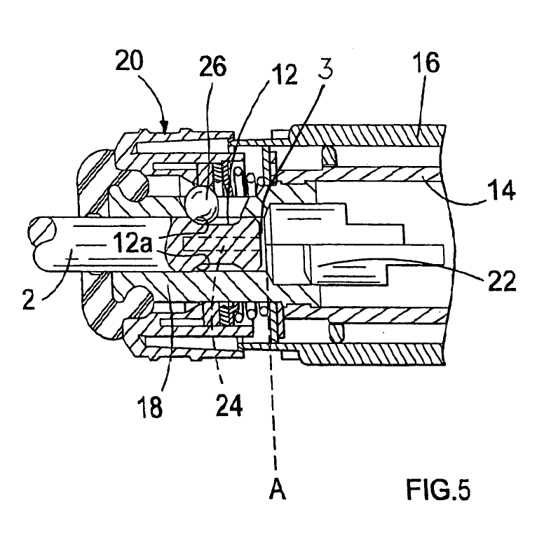

The tool of FIGS. 3 and 4 has a shank portion (2) for fitment within a tool holder of a rotary hammer and a forward portion (4) of reduced diameter, formed with a flat head screw driving tip (30) at its forward end (5). Alternatively, the tip (30) could be a cross-head or other type of screw or nut driving tip, many of which are well known in the art.

FIG. 5 shows the tool of FIGS. 1 and 2 or 3 and 4 fitted into a tool holder (20), which tool holder is mounted at the forward end of a rotary hammer. The rotary hammer has a spindle (14) rotatably mounted within the housing of the hammer (16) and having a forward tool holder portion (18). When the hammer is switched to a rotary mode, the spindle (14, 18) is rotatingly driven. The spindle (14) houses a hammering mechanism. When the hammer is switched to a hammering mode the hammering mechanism generates repeated impacts which are usually transferred by a beatpiece (22) reciptcatingly mounted within the spindle (14) to the rearward end of a tool mounted within the tool holder (20).

The shank portion (2) of the tools of FIGS. 1 to 4 has a diameter of 10 mm and is formed at its rearward end (3) with two axially extending opposing driving grooves (10) (shown in dotted lines in the Figures) which extend to the rearward end of the tool and are open at the rearward end of the tool. The driving groove has a length of 12 mm, but may be between 10 and 12 mm, and includes a closed forward end (10a). When the shank (2) is fitted into the tool holder (20), corresponding splines (24) (shown in dotted lines) formed in the tool holder slide into the grooves (10) to form a driving engagement. Thus, any rotary drive transmitted to the tool holder portion (18) of the spindle (14) is transmitted to the tool via the driving grooves (10).

In addition the shank portion (2) of the tool is formed at its rearward end (3) with a pair of axially extending closed grooves (12) one of which engages with a corresponding locking element (26) of the tool holder. The closed grooves (12) have an axial length of 10 mm, but may be between 7 mm and 20 mm. The forward ends (12a) of the grooves (12) are a shorter distance from the rearward end (3) of the tool than is conventional and so the tool shank (2) is locked in a position in the tool holder (20) which is further forward in the tool holder than is conventional. The closed grooves (12) are formed so that when the tool shank portion (2) is locked within a tool holder (20) the rearward end of the tool (3) is always positioned forwardly of the most forward position (shown in the top half of FIG. 5) of the beatpiece (22). The most forward position of the front of the beatpiece (22) is the most forward position of the hammering mechanism and is shown by the dotted line (A). Therefore, when the tool shown in FIGS. 1 and 2 or 3 and 4 is locked in the tool holder (20) of FIG. 5, if the rotary hammer is inadvertently switched into a hammering mode, the beatpiece (22) will be unable to impact the rear (3) of the tool and so the tool is prevented from being destroyed. The forward ends of the grooves (12a) are a distance of 14 mm from the rearward end (3) of the tool, although this distance may be between 14 mm and 20 mm while still avoiding impact to the tool shank from the hammering mechanism. The distance between the rearward end (3) of the tool and the rearward end of the closed grooves (12) is 4 mm, but this may vary in the range of 3 to 5 mm.

In the above embodiments the shank is described as having two driving grooves and two closed grooves, however, a greater or lesser number of each type of groove could be utilised. For example, it is well known to use three driving grooves.

As an alternative to the use of driving grooves (10) to transmit rotary drive from the tool holder to the tool, it is also possible for the shank of the tool to have a non-circular transverse cross-section, for example a hexagonal cross-section, so that rotary drive can be transmitted from a tool holder formed for example with a bore for receiving the tool having the same transverse cross-section as the tool.

1. A tool suitable for being releasably locked in a rotary hammer having a tool holder including a locking body and a beatpiece capable of reciprocating between a rearwardmost position and a forwardmost position, the tool comprising:
a forward end and a rearward end;
a tip at the forward end; and
a shank portion at the rearward end, the shank defining a closed groove for engagement by the locking body of the rotary hammer, wherein the closed groove has a forward end which is located sufficiently close to the rearward end of the tool so that, when the tool is locked in the tool holder of the rotary hammer, the rear end of the tool is always maintained forwardly of the forwardmost position of the beatpiece.

2. A tool according to claim 1 wherein the closed groove is a first closed groove and the shank defines a second closed groove radially opposite the first closed groove.

3. A tool according to claim 1 including an axially extending driving groove defined by the shank and extending to and open at the rearward end of the tool and engageable by the tool holder of the rotary hammer so as to transmit rotary drive to the tool.

4. A tool according to claim 1 further including a shank portion having a non-circular transverse cross-section engageable by the tool holder of the rotary hammer so as to transmit rotary drive to the tool.

5. A tool according to claim 4 wherein the shank portion of noncircular transverse cross section has an hexagonal cross section.

6. A tool according to claim 1 which is a tile cutting tool and the tip is a cutting tip suitable for cutting ceramic materials.

7. A tool according to claim 6 wherein the cutting tip is an arrow shaped carbide tip fixed in a transverse notch formed at the forward end of the tool.

8. A tool according to claim 1 wherein the tool is a driving tool.

9. A tool according to claim 1 further comprising an axially extending driving groove defined by the tool shank and extending to and open at the rearward end of the tool and engageable by the tool holder so as to transmit rotary drive to the tool, the driving groove having a forward end, and wherein the forward end of the closed groove and the forward end of the driving groove are substantially the same distance from the rearward end of the tool.

10. A tool according to any claim 1 wherein the distance between the forward end of the closed groove and the rearward end of the tool is less than 20 mm.

11. A tool according to claim 10 wherein the distance between the forward end of the closed grooves and the rearward end of the tool is between 14 mm and 20 mm.
